(19) United States
(12) Patent Application Publication
(10) Pub. No.: US 2006/0098628 A1
(43) Pub. Date: May 11, 2006

(54) Methods and apparatus for controlling signaling gateways

(76) Inventors: Philippe Bouckaert, Blot (FR); Pierre Garnero, Grasse (FR); Herve Troadec, Le Golfe-Juan (FR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/243,059

(22) Filed: Oct. 4, 2005

(30) Foreign Application Priority Data
Oct. 4, 2004 (EP) 04300652.7

(51) Int. Cl. H04L 12/66; H04L 12/56

(52) U.S. Cl. 370/352; 370/401; 370/522; 370/389

(57) ABSTRACT

One embodiment of a method for operating a signaling gateway process determines routing information enabling an application server process to discriminate a signaling message and makes the routing information available to the application server process together with the signaling message payload.

### CLAIM TO PRIORITY

This application claims priority to copending European patent application entitled, “Methods and Apparatus for Controlling Signalling Gateways,” having serial number EP 04300652.7, filed Oct. 4, 2004, which is entirely incorporated herein by reference.

### TECHNICAL FIELD

The present disclosure relates to methods, and related apparatus, for controlling processing entities used, for instance, in communication systems such as for the control of signaling traffic between a signaling gateway and a plurality of application server processes.

### BACKGROUND

Establishing connections between two telephones involves a complex interaction of digital messages, hereinafter referred to generally as signaling. Nowadays telephone systems perform what is known as “out-of-band” signaling. Out-of-band signaling means that the communications required between the switches and other equipment in the network take place on communication channels other than the channel by which the voice or data flows. Typically, the out-of-band signaling takes place by means of digital communication channels. Thus, the public switched telephone network (PSTN) generally uses two types of channels, media and signaling.

Several protocols have been defined for out-of-band signaling. The most commonly used protocol, in North America, Asia and Europe, is known as Signaling System No. 7 (SS7). However, the SS7 protocol defines more than just a protocol for communication between switches. It also defines an entire switching network for facilitating signaling for call establishment, routing, and information exchange functions of switched circuit networks.

Since the amount of data transferred over data networks is now much larger than the voice traffic that is carried over the PSTN, carriers are in the process of consolidating both types of networks. In addition, telecommunication networks are increasingly making use of standard computing hardware in order to reduce IT costs.

Therefore, there is a trend in the telephone industry to migrate telephone systems using SS7-based networks for signaling to Internet Protocol (IP) networks. The Internet protocols are standardized by the Internet Engineering Task Force (IETF). Moving either or both of the media and signaling channels to an IP infrastructure involves the use of very different technologies and can be done independently. The SIGTRAN IETF working group is currently in the process of defining the protocols for back-hauling SS7 signaling messages across IP networks. Generally speaking, signaling across an IP network involves replacing the lower levels of the SS7 layered protocol communications and transport layers with IP network-protocol communications and transport layers.

The SIGTRAN group has taken the initiative to define open standards for transporting SS7 over IP networks. With SIGTRAN technology, telephone services which today lie on top of SS7 networks, can run Application Servers (ASs) lying on top of IP networks. The interworking with SS7 networks is performed by SIGTRAN signaling gateways (SGs).

To enhance the availability of the signaling gateway, it can be distributed over several processes running in one or several computers, each of them being a Signaling Gateway Process (SGP). Every SGP belonging to a particular SG has the same SS7 point code (or the same list of PCs), with each SGP generally being connected to the SS7 network through redundant links that are selected in conventional manner via Signaling Link Selector (SLS) values present in the SS7 messages.

On the IP network side, each SGP is connected to the ASPs running the services. Each AS, which can typically be identified with a single logical service, such as a Short Message Service Center(SMSC), can also be implemented in a distributed manner by one or more processes or computers - referred to as the ASPs. To provide improved reliability, each SGP is typically directly connected to each ASP through a Stream Control Transfer Protocol (SCTP) association such that there is one association between each SGP and each ASP.

As is well known, the Short Message Service (SMS) enables mobile subscribers to easily send and receive text messages via a wireless handset. The SMS delivery service provides a mechanism for transmitting such short messages to and from SMS-capable terminals (e.g., wireless handsets, personal computers, etc.) via the signaling component of the wireless communication network. A Short Message Service Center (SMSC) functions as a store and forward platform for short messages so that if a temporary network failure prohibits the immediate delivery of an SMS message, then the short message is stored in the network (i.e., at an SMSC) until the destination becomes available.

However, as the popularity of mobile telephones rises, SMS messaging is becoming widely used as an advertising vehicle. As such, SMS users are increasingly finding themselves receiving unwanted SMS messages, often referred to as “spam” or “junk” messages. From a network operations perspective, large volumes of spam SMS messaging traffic has the potential to impact overall network performance. In consequence, various techniques are being developed and deployed to prevent the delivery of unwanted SMS messages to a mobile subscriber and to eliminate such unwanted SMS message traffic from an operator's network to conserve network resources.

### SUMMARY

The present disclosure is directed to facilitating the filtering of message traffic where the traffic is backhauled to an IP-based application server, such as an IP-based SMSC.

In brief, one embodiment of the present disclosure provides a facility whereby additional message related information may be made available to an application server to enable unwanted messages to be identified, or messages to be otherwise discriminated.

One issue that arises with eliminating unwanted messages is that of spoofing, in other words, a message may contain false information designed to hide the message's true origin. For this reason it is often necessary to inspect a range of information concerning the message in order to determine whether or not it is an unwanted message. However, the standard SIGTRAN xUA protocols do not normally provide to the application servers all the information they have available regarding particular messages. In particular, routing information is normally not needed by the AS, and is thus not transported inside the xUA protocols.

However, such routing information may be exploited to discriminate messages within the AS. For instance, an anti-spoofing criteria may be to check the calling party address of the message received against the linkset ID reflecting the linkset upon which the message was received at the gateway. The global title of the calling party address may, for instance identify the network operator through the first gtai digits, and this information must be consistent with the SS7 interface, characterized by a linkset ID, provided to this operator. To be able to check this criteria, for instance, the Application Server would need access to this routing information.

One embodiment of a method is thus provided for operating a signaling gateway process comprising determining routing information enabling an application server process to discriminate a signaling message and making the routing information available to the application server process together with the signaling message payload, in a DATA or CLDT message for instance.

In one embodiment, a registration step is provided for whereby an application server process may select the routing information made available to it by the signaling gateway. The gateway process then responds to the registration by providing the requested information.

In another aspect, one embodiment of the present disclosure provides a system for identifying unwanted short message service messages comprising: a signaling gateway having a facility for making routing information concerning the message available to an application server, and an application server having a discrimination element for using the routing information to determine whether the message is an unwanted message.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

An embodiment of the present disclosure will now be described, by way of example only, with reference to the accompanying drawings in which:

FIG. 1 shows the general configuration of a signaling gateway;

FIGS. 2a and 2b illustrate the layered protocol communications schemes of a Signaling End Point, a Signaling Gateway Process and an Application Server Process;

FIG. 3 illustrates an exemplary SS7 topology;

FIG. 4 shows an exemplary sequence of events and signaling network management message exchanges;

FIG. 5 shows a flow chart describing one embodiment of a method of operating a signaling gateway process; and

FIG. 6 shows a flow chart describing one embodiment of a method for operating a signaling system comprising a signaling gateway process and an application server process.

### DETAILED DESCRIPTION

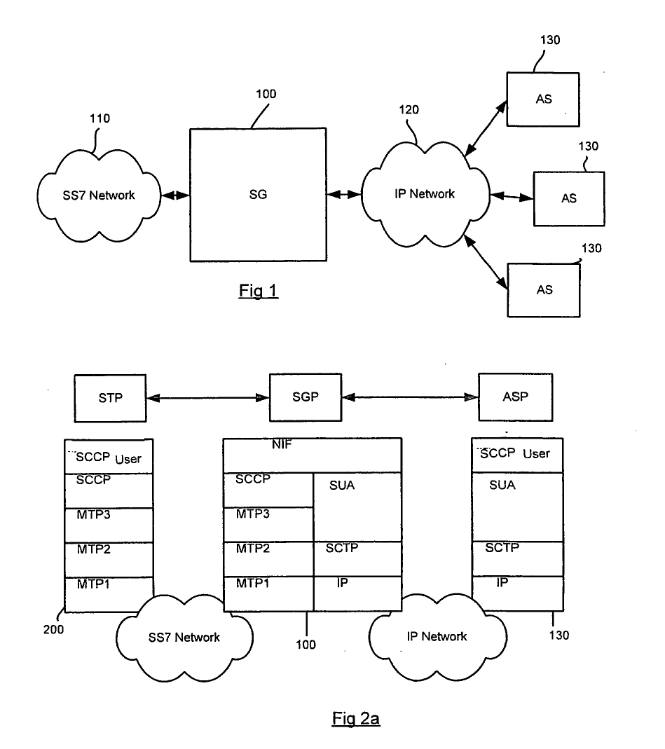

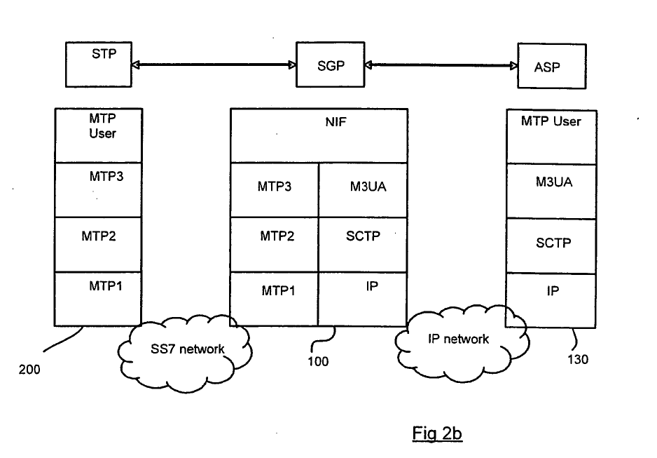

FIG. 1 shows the general configuration of a signaling gateway 100 interconnecting an SS7 network 110 and a series of Application Servers (ASs) 130 via an IP Network 120. FIGS. 2a and 2b illustrate the layered protocol communications architecture of the various components.

SS7 Signal Transfer Point (STP) or Signal End Point (SEP) 200 includes the MTP 1, MTP2, MTP3, SCCP and SCCP user part layers. As is known in the prior art, a Signal Transfer Point (STP) or Signal End Point (SEP) 200 routes SS7 signaling within the SS7 network and manages various signaling links which comprise the SS7 network. Routing is accomplished by processing of the routing label of an SS7 message by the Message Transfer Part (MTP) functionality. The MTP layers comprise three levels. Levels 1 and 2 are used for the transfer of SS7 messages from one point to another over an individual signaling link. Level 3 is used for the transfer of SS7 messages over the SS7 network beyond the requirements of individual link transmission. The MTP3 layer is mainly dedicated to ensuring the delivery of incoming and outgoing messages (such as discrimination, distribution and routing), and the network reconfiguration (such as traffic management, route management and link management).

Communication between Signaling Gateway Processes (SGPs) of the SG 100 and Application Server Processes (ASPs) within the ASs 130 is carried out using a transport layer defined by the SIGTRAN working group and referred to as SCTP (Stream Control Transfer Protocol) which is defined in RFC 2960. Signaling Gateway 100 terminates the MTP 1, MTP2, MTP3 and SCCP layers and includes a Nodal Interworking function (NIF) as well as SUA, SCTP and IP layers. Each AS 130 includes IP, SCTP, SUA and SCCP user layers. Signaling Gateway 100 thus terminates the SS7 lower layers and encapsulates their payload data into SCTP messages to send them to an Application Server 130. The AS terminates the SCTP layers, processes the signaling messages and replies to the SG 100 in the same way.

In the case of SS7 and M3UA interworking, the M3UA adaptation layer is designed to provide an extension of the MTP3 layer as shown in FIG. 2b. In this document,, the SUA and M3UA layers are referred to as xUA layers.

These architectures are well known to those skilled in the relevant art and are described in the SIGTRAN documents, referred to above.

The M3UA and SUA standards define the sets of messages exchanged between the xUA layers including management messages, transfer messages, signaling network management messages, state maintenance messages and traffic maintenance messages.

Of the traffic management messages, the ASP-ACTIVE message is sent by an ASP to indicate to a remote xUA peer that it is ready to process signaling traffic for a particular Application Server. The ASP-ACTIVE message affects only the ASP state for the Routing Keys identified by the Routing Contexts, if present.

The ASP-ACTIVE message contains the following parameters:
Traffic Mode Type Optional
Routing Context Optional
INFO String Optional

An ASP-ACTIVE_ACK message is used by the SG 100 to acknowledge an ASP-ACTIVE message received from a remote xUA peer.

The ASP-ACTIVE_ACK message contains the following parameters:
Traffic Mode Type Optional
Routing Context Optional
INFO String Optional

In both cases, the optional INFO String parameter is defined so as to be able to carry any meaningful UTF-8 character string along with the message. The length of the INFO String parameter is from 0 to 255 octets.

A M3UA DATA transfer message as defined in RFC 3332 contains the SS7 MTP3-User protocol data, which is an MTP-TRANSFER primitive, including the complete MTP3 Routing Label. The DATA message contains the following variable length parameters:
Network Appearance Optional
Routing Context Conditional
Protocol Data Mandatory
Correlation Id Optional

The equivalent message in the case of SUA, as defined in the IETF working drafts “Signaling Connecting Control Part User Adaptation Layer (SUA)” is a CLDT connectionless data transfer message which contains the following parameters:
Routing Context Mandatory
Protocol Class Mandatory
Source Address Mandatory
Destination Address Mandatory
Sequence Control Mandatory
SS7 Hop Count Optional
Importance Optional
Message Priority Optional
Correlation ID Optional
Segmentation Optional
Data Mandatory

In this embodiment, the parameters of the DATA message in the case of M3UA and the CLDT message in the case of SUA are supplemented with an optional INFO String parameter.

This enables protocols to be defined, an example of which will be described below, which are based on messages embedded in the above-described SIGTRAN messages by means of the usage of INFO string field to transport supplementary information. By taking advantage of this extra information, the ASPs are provided with a wider range of criteria by which they can verify the authenticity of, or otherwise discriminate between, messages.

To define the structure and the message exchanges, a new protocol, embedded in the SIGTRAN messages, is defined. This protocol, which will be referred to as SS7_INFO in this document, is implemented by 5 messages:

SS7_INFO_REGISTER

The ASP sends this message to the SGP, in an ASP-ACTIVE SIGTRAN message, or in any DATA (or CLDT in the case of SUA) message. The message has two purposes; (i) to verify that the remote SGP is configured to use the SS7_INFO protocol; and (ii) to indicate to the SGP that this ASP could request, from the SGP, SS7_INFO information. The information requested is indicated inside this message.

This message is optional, and is used for dynamic registration. In other embodiments, SG 100 may also be configured in a static way, to send SS7 routing information in all DATA (or CLDT) messages for a specific ASP.

SS7_INFO_REGlSTER_ACK

This message is sent by the SGP to the ASP, in an ASP-ACTIVE-ACK SIGTRAN message or a DATA (or CLDT) message, in response to a received SS7_INFO_REGISTER message, to indicate that: (i) The SGP supports the SS7_INFO protocol; and (ii) To indicate which supplementary SS7 routing information the SGP is able to send within the DATA messages.

SS7_INFO_DEREGISTER

The ASP sends this message to the SGP, in any DATA (or CLDT) message, to request that the SGP stop sending the SS7 routing information.

SS7_INFO DEREGISTER_ACK

This message is sent by the SGP to the ASP, in any DATA (or CLDT) message, in response to a received SS7_INFO_DEREGISTER message.

SS7_INFO_DATA

This message is sent by the SGP to the ASP, in any DATA (or CLDT) message, with the SS7 routing information associated with this message.

As the INFO string field must contain only ASCII characters, the messages of the SS7_INFO protocol are based on ASCII only and an example ABNF grammar description is given below:

SS7_INFOMessage = SS7_INFOToken SLASH Version SEP messageBody
messageBody = 1*1 (SS7_InfoRegister /

```
  SS7_InfoRegisterAck /
SS7_InfoDeregister /
  SS7_InfoDeregisterAck /
  SS7_InfoData)
```

SS7_InfoRegister = SS7_InfoRegisterToken EQUAL LBRKT
SS7_InfoRegisterParameters RBRKT
SS7_InfoRegisterAck=SS7_InfoRegisterAckToken EQUAL BRKT
SS7_InfoRegisterParameters RBRKT
SS7_InfoData = SS7_InfoDataToken EQUAL LBRKT SS7_InfoDataParameters RBRKT
SS7_InforegisterParameters = [SS7_LinksetToken [COMMA]]

[SS7_SLCToken [COMMA]]
[SS7_DPCToken [COMMA]]
[SS7_OPCToken]

SS7_InfoDataParameters = [SS7_LinksetToken EQUAL LINKSET_ID [COMMA]]

[SS7_SLCToken EQUAL SLC_ID [COMMA]
[SS7_DPCToken EQUAL PC [COMMA]]
[SS7_OPCToken EQUAL PC]

LINKSET_ID = 1*3 (DIGIT)

| | |
|---|---|
| SLC_ID | = 1*2 (DIGIT) |

| | |
|---|---|
| PC | = (1*5 (DIGIT) / |

1*3 (DIGIT) EQUAL 1*3 (DIGIT) EQUAL 1*3 (DIGIT)/
1*8 (DIGIT) ) ;itu-t / ansi / china format

Version = 1*2(DIGIT) ; today, only version 1 is defined

| | | |
|---|---|---|
| DIGIT | = %x30-39 | ; 0-9 |

| | | |
|---|---|---|
| SLASH | = %x2F | ; ″/″ |

| | | |
|---|---|---|
| SP | = %x20 | ; space |

| | | |
|---|---|---|
| HTAB | = %x09 | ; horizontal tab |

| | | |
|---|---|---|
| CR | = %x0D | ; Carriage return |
| LF | = %x0A | ; linefeed |

| | |
|---|---|
| EOL | = (CR [LF] / LF) |
| WSP | = SP / HTAB ; white space |
| SEP | =( WSP / EOL) |

| | |
|---|---|
| LWSP | = * ( WSP / EOL ) |

| | |
|---|---|
| LBRKT | = LWSP %x7B LWSP ; ″{″ |

| | |
|---|---|
| RBRKT | = LWSP %x7D LWSP ; ″}″ |

| | |
|---|---|
| COMMA | = LWSP %x2C LWSP ; ″,″ |
| EQUAL | = LWSP %x3D LWSP ; ″=″ |

| | |
|---|---|
| SS7_INFOToken | = (″SS7_INFO″) |

| | |
|---|---|
| SS7_InfoRegisterToken | = (“REG”) |

| | |
|---|---|
| SS7_InfoRegisterAckToken | = (“RACK” / “RNAK”) |

| | |
|---|---|
| SS7_InfoDeregisterToken | = (“DEREG”) |

| | |
|---|---|
| SS7_InfoDeregisterAckToken | = (“DEACK” / “DENAK”) |

| | |
|---|---|
| SS7_InfoDataToken | = (“DATA”) |

| | |
|---|---|
| SS7_LinksetToken | = (”LKST”) |

| | |
|---|---|
| SS7_SLCToken | = (”SLC”) |
| SS7_DPCToken | = (”DPC”) |
| SS7_OPCToken | = (”OPC”) |

It will be appreciated that a decoder of such a grammar can be readily implemented with commonly available tools.

It will be apparent that in this example, 3 parameters may be requested by the ASP, that is the OPC Originating Point Code, DPC Destination Point Code and SLC Signaling Link Code and Linkset ID LKST.

In the following, an example will be given of behavior for the system illustrated in FIG. 1. Each component is assumed to be configured to make use of the SS7_INFO protocol.

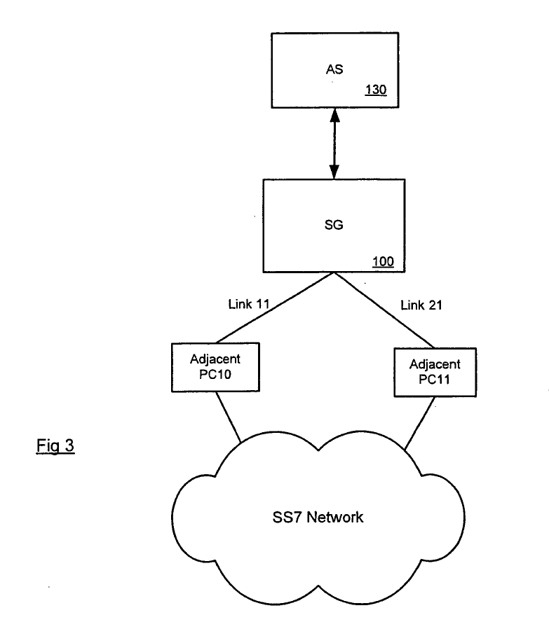

The exemplary SS7 topology shown in FIG. 3 is as follows: The SG 100 is connected in associated mode to 2 adjacent nodes: PC 10 and PC 11. SG 100 contains 2 signaling links: link 11 and Link 21. SG 100 is connected to PC 10 by linkset 1 and to PC 11 by linkset 2. A linkset is a number of signaling links that directly interconnects two signaling points and which are used as a module—links within the linkset being selected by means of the SLS values in each message.

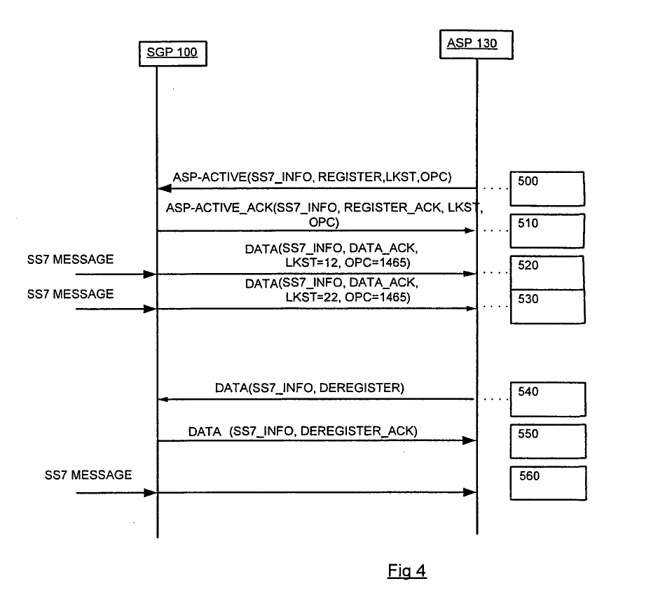

An exemplary sequence of events and signaling network management message exchanges is shown in FIG. 4.

Initially, the AS 130 signals in conventional manner to the SG 100 that it is up using respective ASP_UP messages which are acknowledged by ASP_UP_ACK. This exchange is not shown in FIG. 4.

The use of the SS7_INFO protocol to pass routing information between AS 130 and SG 100 will now be described in relation to steps 500 to 560 as follows.

Step 500: When AS 130 is able to handle traffic it informs SG 100 by sending an ASP-ACTIVE message in which a SS7_INFO message is embedded. The SS7_INFO message is formatted as follows:

SS7INFO/1 {REG, LKST, OPC}.

Which indicates that AS 130 is requesting that the linkset ID, i.e. the ID of the linkset upon which the message was received by SG100, and originating point code be communicated.

Step 510: SG 100 replies to ASP 130 using an ASP-ACTIVE_ACK message in which is embedded an SS7_INFO_ACK message. SG 100 has the SS7_INFO capability, and thus it authorizes AS 130 to take advantage of this capability and it informs AS 130 that is able to supply the linkset ID and originating point code data for each message. The message is formatted as follow:

SS7_INFO/1 {REG_ACK, LKST, OPC}

Step 520: When an SS7 message is received by SG 100 it is transferred to AS 130 in the normal way, except that the INFO field of the DATA message contains the supplementary information requested by AS130. In the example illustrated, the linkset ID is 12 and the OPC is 1465.

Step 530: A further SS7 message is received by SG 100 and is transferred to AS 130 with the INFO field of the DATA message containing the supplementary information requested by AS 130. In this further message, the linkset ID is 22 and the OPC is 1465.

ASP 130 can thus distinguish between the message received from point code 1465 on linkset 12 in step 520 and the message received from point code 1465 on linkset 22 in step 530.

It is possible that the AS 130 knows that all bona fide messages received from OPC 1465 are to be received on linkset 22 and therefore AS 130 can use the supplementary information contained in the SS7_INFO message to determine that the message received in step 530 is not bone fide and should not be processed.

Step 540: In step 540, AS 130 sends an SS7_INFO DEREGISTER message to inform SG 100 to cease sending the supplementary information. This message in acknowledged in step 550 by and SS7_INFO DEREGISTER_ACK message. A subsequent message received in step 560 then does not contain the supplementary information.

The foregoing discussion is premised upon one of ordinary skill in the art having a working understanding of the character and format of switching signals in the SS7 network, as well as the character and nature of converting SS7 signals for transport across IP networks. For additional information regarding SS7 network switching over IP networks, reference may be made to the (IETF) working drafts “Signaling Connecting Control Part User Adaptation Layer (SUA)” available from the IETF website at www.ietf.org, and IETF RFC 3332 “SS7 MTP3—User Adaptation Layer (M3UA)”, available from the IETF website, and which is incorporated herein by reference as if reproduced in full. It is noted that each of these IETF documents is a work in progress and is therefore subject to change. However, these documents exemplify the changes necessary to a standard SS7 signaling system for its implementation in an IP network context. As well as defining the functions of signaling gateways and signaling gateway processes, the SIGTRAN documents referred to above specify in detail the protocols to be implemented between an SGP and an ASP.

More general background information regarding SIGTRAN protocols, reference may be made to the International Engineering Consortium, in document “SS7 Over IP Signaling Transport and SCTP,” which is available from the IEC website www.iec.org, and which is incorporated herein by reference as if reproduced in full.

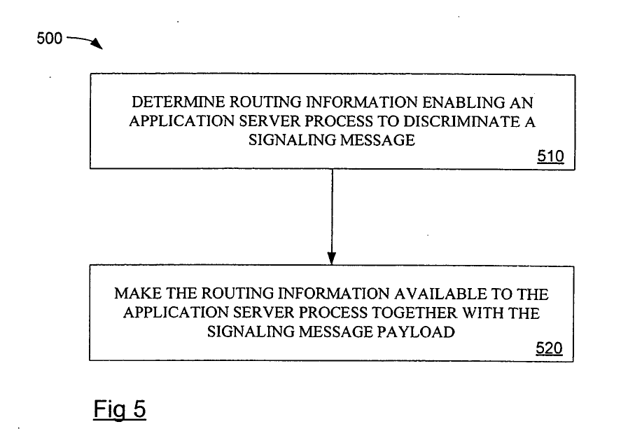

Referring now to FIG. 5, a flow chart describing one embodiment of a method (500) of operating a signaling gateway process is shown. The first step (510) of the flow chart involves determining routing information enabling an application server process to discriminate a signaling message. Then, in step 520, the routing information is made available to the application server process together with the signaling message payload.

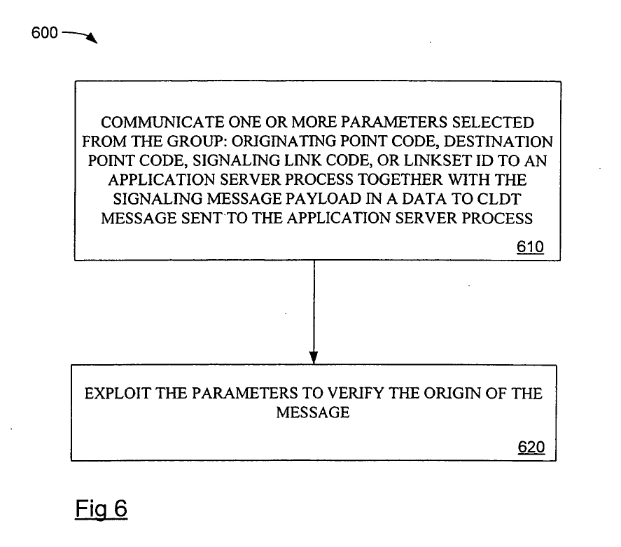

Next, FIG. 6 shows a flow chart describing one embodiment of a method for operating a signaling system comprising a signaling gateway process and an application server process. The method (600) includes the steps of communicating (610) (via the signaling gateway process) one or more parameters selected from the group: Originating Point Code, Destination Point Code, Signaling Link Code, or Linkset ID, to the application server process together with the signaling message payload in a DATA to CLDT message sent to the application server process. The method (600) further includes the step of exploiting (620) (via the application server process) the parameters to verify the origin of the message.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

It will be appreciated that the present embodiments take the form of a set of computer programs intended for use with general purpose computing and signaling platforms and which may be marketed in the form of suitable computer program products including the functionality described. It will be appreciated that the present disclosure may equally be implemented as special purpose hardware or any combination of software and hardware.

Therefore, having thus described the invention, at least the following is claimed:

1. A method for operating a signaling gateway process comprising determining routing information enabling an application server process to discriminate a signaling message and making said routing information available to the application server process together with the signaling message payload.

2. A method as claimed in any preceding claim wherein the determined routing information is made available to the application server process in an DATA to CLDT message sent to the application server process.

3. A method as claimed in claim 1 including a registration step whereby an application server process may select the routing information made available to it by the signaling gateway.

4. A method as claimed in claim 1 wherein the routing information comprises one or more parameters selected from the group: Originating Point Code, Destination Point Code, Signaling Link Code, or Linkset ID.

5. A method as claimed in claim 1 wherein the routing parameters are exchanged within an INFO String parameter of otherwise standard SIGTRAN xUA transfer messages.

6. A signaling gateway element arranged to carry out a method as claimed in claim 1.

7. A method for operating a signaling system comprising a signaling gateway process and an application server process, the method comprising the signaling gateway process communicating one or more parameters selected from the group: Originating Point Code, Destination Point Code, Signaling Link Code, or Linkset ID, to the application server process together with the signaling message payload in a DATA to CLDT message sent to the application server process and the application server process exploiting the parameters to verify the origin of the message.

8. A method as claimed in claim 7 including a registration step whereby an application server process may select the parameters made available to it by the signaling gateway.

9. A method as claimed in claim 7 wherein the routing parameters are exchanged within an INFO String parameter of otherwise standard SIGTRAN xUA transfer messages.

10. A system for identifying unwanted short message service messages comprising:
a signaling gateway having a facility for making routing information concerning the message available to an application server, and
an application server having a discrimination element for using the routing information to determine whether the message is an unwanted message.
